(19) United States
(12) Patent Application Publication
(10) Pub. No.: US 2026/0048970 A1
(43) Pub. Date: Feb. 19, 2026

(54) SYSTEMS AND METHODS FOR LOAD HEIGHT AND OVERHEAD CLEARANCE ESTIMATION FOR THE AUTONOMOUS LOADING AND UNLOADING OF PALLETS

(71) Applicant: Fox Robotics, Inc., Austin, TX (US)

(72) Inventors: Peter Anderson-Sprecher, Austin, TX (US); Aaron Dennis, Austin, TX (US); Arun Joseph, Austin, TX (US)

(21) Appl. No.: 18/808,156

(22) Filed: Aug. 19, 2024

(51) Int. Cl. B66F 9/075; B66F 9/12; B66F 17/00

(52) U.S. Cl. CPC B66F 9/0755; B66F 9/12; B66F 17/003

(57) ABSTRACT

The present invention relates, in general, to systems and methods for controlling autonomous forklifts, and specifically, for maneuvering autonomous forklifts in environments where there is low overhead clearance or overhead obstacles. The invention determines the height of an overhead obstacle as well as the height of a pallet carried by the autonomous forklift, and also determines if the overhead obstacle is deformable or non-deformable. The autonomous forklift is commanded to either traverse through the overhead obstacle if the height of the pallet is smaller than the height of the overhead obstacle, or if the overhead obstacle is deformable, such as in the case of weather guards surrounding a dock door.

### BACKGROUND

### Field of the Invention

The present invention relates, in general, to computer implemented systems and methods for controlling autonomous forklifts, and specifically, for maneuvering autonomous forklifts in environments where there is low overhead clearance or overhead obstacles.

### Description of Related Art

Warehouses typically include multiple loading dock stations that facilitate the movement of goods between the warehouse and a vehicle, such as a semi-truck trailer, parked at the loading dock. Goods being delivered by or loaded onto trailers are typically stored on pallets, which are flat transport structures configured to hold goods for easier transportation by vehicles and other equipment, such as forklifts, operating in the warehouse.

Traditionally, human personnel have operated forklifts. However, with advances in autonomous vehicle technology, autonomous forklifts are increasingly being used in warehouse environments to lift and place pallets, as well as to transport pallets between various locations, such as to and from trailers parked at loading docks. While such technological advancement allows for increased operational efficiency within warehouses, autonomous forklifts face collision risks when operating in environments where there is low overhead clearance or overhead obstacles.

Trailers are typically loaded to their maximum capacity to increase operational efficiency and profit. However, such maximum capacity loading and stacking of pallets within trailers poses significant challenges for pallet loading and unloading operations by autonomous forklifts, given the proximity of pallets to the trailer ceiling and other overhead obstacles. Furthermore, these challenges are exacerbated by unevenness of dock levelers that provide trailer ingress and egress paths for autonomous forklifts.

For example, 53-foot long trailers in North America are typically about 108 inches tall in height, and shipping containers and smaller trucks/trailers are often shorter in height. Dock doors are commonly 92 inches to 100 inches in height, leaving a significant margin between the two heights that reduces the overhead clearance when pallets are being transported between a loading dock and a trailer. In addition, weather guards are commonly affixed around the inner periphery of the dock door, and the trailer itself oftentimes includes equipment such as refrigeration units, temperature zone separators, and lighting hangs below the trailer ceiling, both of which further complicates the overhead clearance issues described above.

Thus, there is a need for systems and methods of measuring the height of pallets being transported by an autonomous forklift, and comparing the height with overhead clearances in the surrounding environment in order to generate motion commands for the autonomous forklift that prevents overhead collisions.

### SUMMARY

In an embodiment, the present invention is direct to an autonomous forklift, comprising: a controller; a fork assembly having an actuator coupled to the controller, the actuator configured to adjust the fork assembly; and a sensor coupled to the controller, the sensor positioned to capture (i) a view above a path of the autonomous forklift, and (ii) a view of a load, wherein the controller is configured to: (1) receive data from the sensor, (2) analyze the data to detect an obstacle above the path of the autonomous forklift, (3) analyze the data to determine a height of the obstacle, (4) analyze the data to determine if the obstacle is deformable or non-deformable, (5) analyze the data to determine a height of the load, (6) if the height of the load is greater than the height of the obstacle, then (i) command the autonomous vehicle to travel through the obstacle if the obstacle is deformable, or (ii) command the autonomous vehicle to avoid travel through the obstacle if the obstacle is non-deformable, and (7) if the height of the load is smaller than the height of the obstacle, command the autonomous vehicle to travel through the obstacle.

In another embodiment, the present invention is directed to an autonomous forklift, comprising: a controller; a fork assembly mounted on a fork side of the autonomous forklift, the fork assembly having an actuator coupled to the controller, the actuator configured to adjust the fork assembly; a first sensor coupled to the controller and mounted on the fork side, the first sensor positioned to capture (i) a view above a path in a direction of the fork side and (ii) a view of a load; and a second sensor coupled to the controller and mounted on a counterweight side of the autonomous forklift, the second sensor positioned to capture a view above a path in a direction of the counterweight side, wherein the controller is configured to: (1) receive first data from the first sensor, (2) analyze the first data to detect an obstacle above the path in the direction of the fork side, (3) analyze the first data to determine a height of the obstacle, (4) analyze the first data to determine if the obstacle is deformable or non-deformable, (5) analyze the first data to determine a height of the load, (6) receive second data from the second sensor, and (7) analyze the second data to detect an obstacle above the path in the direction of the counterweight side.

In yet another embodiment, the present invention is direct to an autonomous forklift, comprising: a controller; a fork assembly having an actuator coupled to the controller, the actuator configured to adjust the fork assembly; and a sensor coupled to the controller, the sensor positioned to capture (i) a view above a path of the autonomous forklift, (ii) a view of a surface traversed by the autonomous forklift, and (iii) a view of a load, wherein the controller is configured to: (1) receive data from the sensor, (2) analyze the data to detect an obstacle above the path of the autonomous forklift, (3) analyze the data to determine a height of the obstacle, (4) analyze the data to detect a height of a surface traversed by the autonomous forklift, (5) determine a clearance height based on a difference between the height of the obstacle and the height of the surface; (6) analyze the data to determine if the obstacle is deformable or non-deformable, (7) analyze the data to determine a height of the load, (8) if the height of the load is greater than the clearance height, then (i) command the autonomous vehicle to travel through the obstacle if the obstacle is deformable, or (ii) command the autonomous vehicle to avoid travel through the obstacle if the obstacle is non-deformable, and (9) if the height of the load is smaller than the clearance height, command the autonomous vehicle to travel through the obstacle.

### BRIEF DESCRIPTION OF THE DRAWINGS

These and other embodiments of the present invention will be discussed with reference to the following exemplary and non-limiting illustrations, in which like elements are numbered similarly, and where:

FIGS. 1A and 1B depict an autonomous forklift, according to an embodiment of the present invention;

FIG. 2 is a block diagram of a control system for the autonomous forklift, according to an embodiment of the present invention;

FIG. 3 is a flowchart illustrating the steps of operation of the control system during a trailer unloading operation, according to an embodiment of the present invention;

FIG. 4 is a flowchart illustrating the steps of operation of the control system during a trailer loading operation, according to an embodiment of the present invention;

FIG. 5 is a side-view diagram of an autonomous forklift depicting fields of view for sensor modules, according to an embodiment of the present invention;

FIG. 6 is a side-view diagram of an autonomous forklift maneuvering on a dock leveler, according to an embodiment of the present invention;

FIG. 7 is a side-view diagram of an autonomous forklift maneuvering within a trailer, according to an embodiment of the present invention;

FIG. 8 is a view illustrating a dock door with a deformable weather guard; and

FIG. 9 is a view illustrating a prior art autonomous forklift system that does not incorporate height estimation.

### DEFINITIONS

The following definitions are meant to aid in the description and understanding of the defined terms in the context of the present invention. The definitions are not meant to limit these terms to less than is described throughout this specification. Such definitions are meant to encompass grammatical equivalents.

As used herein, the term “autonomous forklift” can refer to, for example, autonomous mobile robots, automatic guided vehicles, vision guided vehicles, semi-autonomous vehicles, and remote-piloted autonomous vehicles, as examples, which serve as equipment, pallet, object, and cargo moving and transport vehicles, including, but not limited to, fork trucks, pallet loaders, side loaders, lift trucks, fork hoists, stacker-trucks, trailer loaders, industrial trucks, pallet jacks, pallet stackers, tow tractors, tugs, and the like.

As used herein, the terms “sensor” and “detector” can refer to, for example, sensing technologies that utilize Light Detection and Ranging (LiDAR), laser scanners, range finders, radar, infrared sensors, sonar, ultrasonic sensors, optical sensors, such as photoelectric sensors, fiber optic sensors, photoconductive devices, reflective sensors, phototransistors, ambient light sensors, infrared sensors, photodiodes, and optical switches, point sensors, proximity sensors, through beam sensors, light curtains, image and video capturing devices, machine vision systems, any combination thereof, and the like.

As used herein, the term “inertial measurement unit” and “IMU” can refer to, for example, accelerometers, gyroscopes, magnetometers, pressure sensors, any combination thereof, and the like.

As used herein, the term “network” can refer to, for example, the Internet, a wide area network (WAN), metropolitan area network (MAN), controller area network (CAN), local area network (LAN), but the network could at least theoretically be of an applicable size or characterized in some other fashion (i.e., personal area network (PAN), home area network (HAN), and the like), a wireless network, a wireless mesh network, a cellular network, a landline network, and/or a short-range connection network (i.e., such as Bluetooth, Zigbee, infrared, and the like). The term “network” can further refer to enterprise private networks, edge networks, and/or virtual private networks.

As used herein, the term “processor” can refer to, for example, any programmable system including systems using micro-controllers, reduced instruction set circuits (RISCs), application specific integrated circuits (ASICs), logic circuits, and any other circuit or processor capable of executing the functions described herein. The above examples are exemplary only, and are thus not intended to limit in any way the definition and/or meaning of the term “processor.”

As used herein, the terms “software” and “firmware” are interchangeable, and can refer to, for example, any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to, for example, a persistent data store with indexing capabilities to expedite query processing. The database can implement various database management systems types such as relational, object-oriented, hierarchical, document-oriented, flat file, object-relational, and any other structured collection of records. The database can be stored locally, remotely, on a cloud environment, and/or on a distributed ledger.

As used herein, the terms “object” and “obstacle”, which are both used interchangeably throughout this application, can refer to hanging, dangling, and/or suspended obstacles.

As used herein, the term “artificial intelligence” can refer to, for example, machine learning, deep-learning, supervised learning, unsupervised learning, semi-supervised learning, generative artificial intelligence, reinforced learning, fuzzy logic, neural networks, historical data and pattern analysis, any combination thereof, and the like.

As used herein, the term “module” can refer to, for example, hardware components, software components, such as source code, packages, libraries, algorithms, and the like, as well as combinations therein.

### DETAILED DESCRIPTION

It should be understood that aspects of the present invention are described herein with reference to the figures, which show illustrative embodiments. The illustrative embodiments herein are not necessarily intended to show all embodiments in accordance with the invention, but rather are used to describe a few illustrative embodiments. Thus, aspects of the invention are not intended to be construed narrowly in view of the illustrative embodiments. In addition, although the present invention is described with respect to its application for an autonomous forklift performing trailer loading and unloading operations, it is understood that the system could be implemented in any autonomous or semi-autonomous vehicle system operating in any environment where navigation may be impeded due to overhead obstacles, including, for example, in a warehouse, a storage facility, a shipping container, and the like.

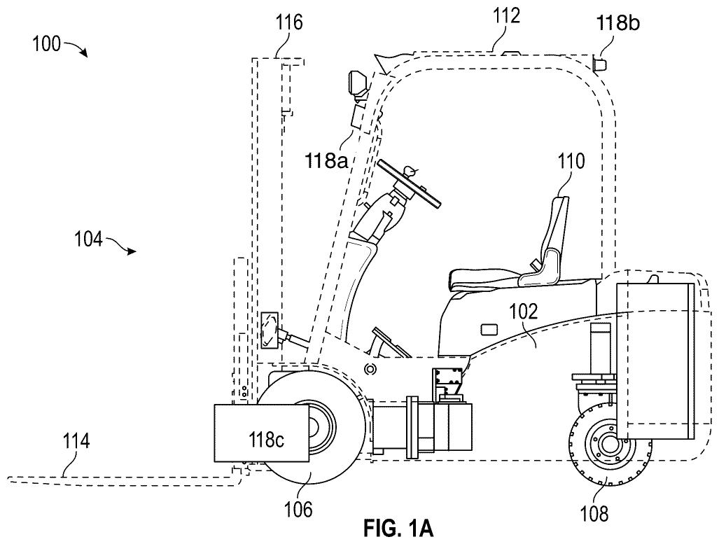

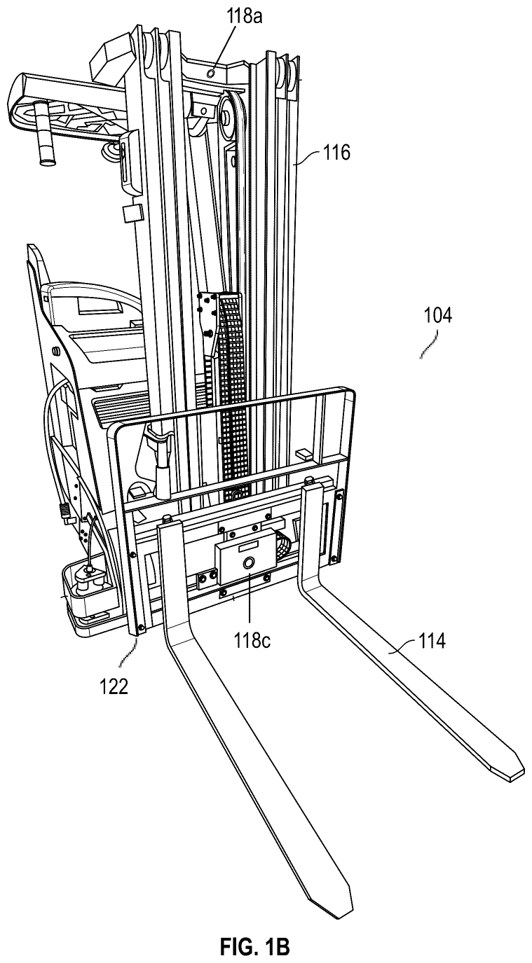

FIGS. 1A and 1B depict an autonomous forklift, according to an embodiment of the present invention. The autonomous forklift 100 includes a body 102 and a load-control system 104 that is coupled to the front of the body 102. An operator's compartment 110 can be provided in the center of the body 102. In one or more embodiments, an operator's compartment 110 may be installed to enable a manual or semi-autonomous operation of the autonomous forklift 100. The body 102 may include an overhead guard 112 that covers the upper part of the operator's compartment 110. Alternatively, in an embodiment, the autonomous forklift 100 may be fully autonomous, without the operator's compartment 110.

The body 102 stands on front drive wheels 106 and at least one rear wheel 108. Specifically, the front pair of wheels are drive wheels 106 and the rear wheel 108 is a steer wheel. The drive wheels 106 provide the power to move the autonomous forklift 100 forward or backwards. In an embodiment, the drive wheels 106 are a plurality of wheels that are mechanically coupled to a chassis of the autonomous forklift 100. The plurality of drive wheels 106 and the rear wheel 108 enable movement of the chassis along a traversed surface. A motor is mechanically coupled to at least one wheel in the plurality of drive wheels 106.

Further, the drive wheels 106 may move only in two directions (e.g., forward and backward), or turn under a plurality of degrees. Additionally, the rear wheel 108 may be responsible for changing the direction of the autonomous forklift 100.

In another embodiment, the rear wheel 108 may provide the drive force in addition to the steering mechanism, while the two front wheels 106 may serve as stabilizers.

The autonomous forklift 100 may be powered by an internal combustion engine, an electric motor, a fuel cell, or a combination thereof, such as in a hybrid powered vehicle.

Further, the load-control system 104 includes a mast 116. The mast may include inner masts and outer masts, where the inner masts are slidable with respect to the outer masts. In an embodiment, the mast 116 may be movable with respect to the vehicle body 102. The movement of the mast 116 may be operated by hydraulic tilt cylinders positioned between the body 102 and the mast 116. The tilt cylinders may cause the mast 116 to tilt forward and rearward around the bottom end portions of the mast 116. Additionally, a pair of hydraulically operated lift cylinders may be mounted to the mast 116 itself. The lift cylinders may cause the inner masts to slide up and down vertically relative to the outer masts.

Further, a right and a left fork 114 are mounted to the mast 116 through a lift bracket, which is slidable up and down vertically relative to the inner masts. In an embodiment, the inner masts, the forks 114, and the lift bracket all provide a vertical lifting function. The load-control system 104 also includes a side-shifter assembly 122, allowing for accurate lateral (i.e., left and right horizontal) positioning of the forks 114. In an embodiment, the side-shift actuation is performed by hydraulically actuated cylinders, in other embodiments the side-shift actuation is driven by electric linear actuators.

Thus, the load-handling assembly 104 provides a horizontal side-shifting function of the forks 114, as well as a vertical lifting and lowering function of the forks 114. In an embodiment, each fork can be laterally adjusted independent of the other fork.

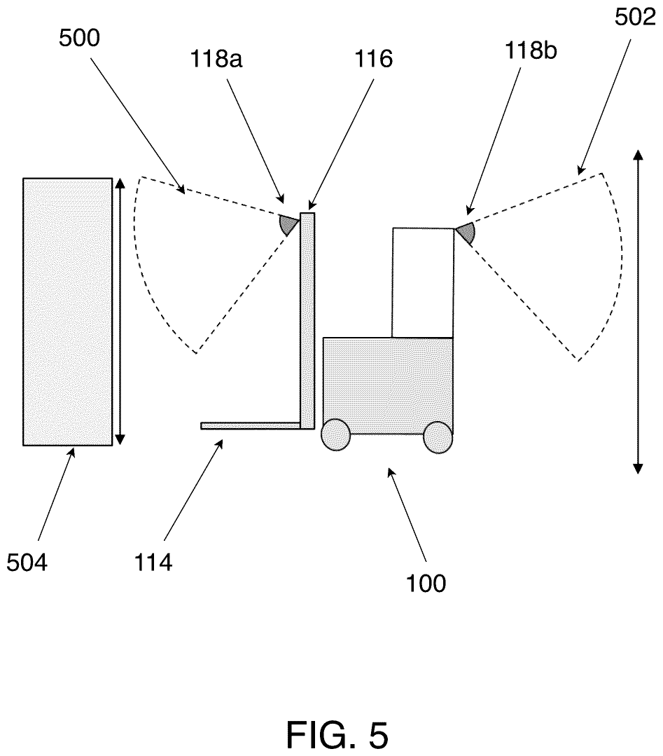

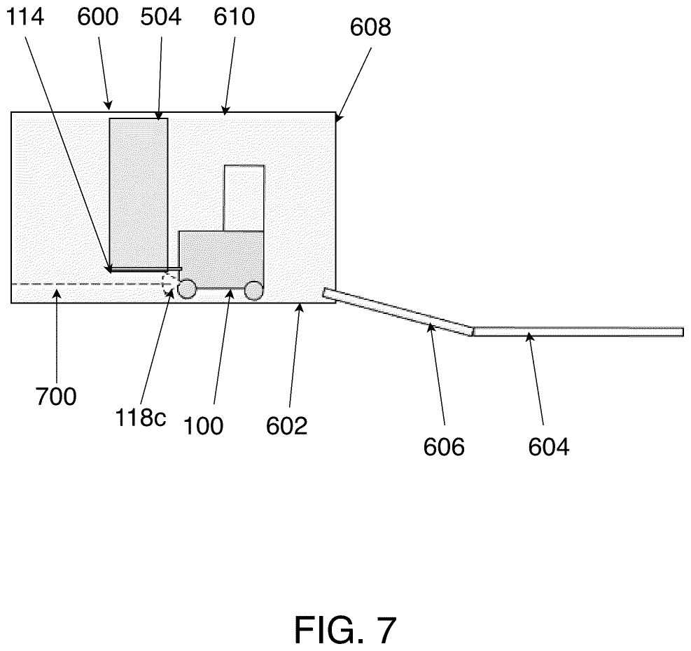

In an embodiment, sensor modules 118 are attached to, and located on, front and rear sides of the autonomous forklift 100, as described herein with respect to FIGS. 5 and 7.

In an embodiment, additional sensor modules can be attached to, and located on, the forks 104, and provide a field of view of the ground or floor that the autonomous forklift 100 is traversing.

In an embodiment, the autonomous forklift 100 includes a counterweight 124 on a side opposite where the load-handling assembly 104 is mounted. The counterweight 124 is used to secure a proper weight distribution and maintain stability, to prevent the autonomous forklift 100 from tipping over, and to ensure the safety performance of the autonomous forklift 100. For the purposes of this invention, the counterweight 124 is mounted on a counterweight side of the autonomous forklift 100, while the load-handling assembly 104, which includes the forks 114, is mounted on a fork side of the autonomous forklift 100.

The autonomous forklift 100 is described in more detail in commonly owned application Ser. No. 18/480,214 entitled “Method and system for operating automated forklift”, filed on Oct. 3, 2023, and commonly owned application Ser. No. 18/410,774 entitled “Method and system for deep learning based perception”, filed on Jan. 11, 2024, both of which are incorporated by reference herein.

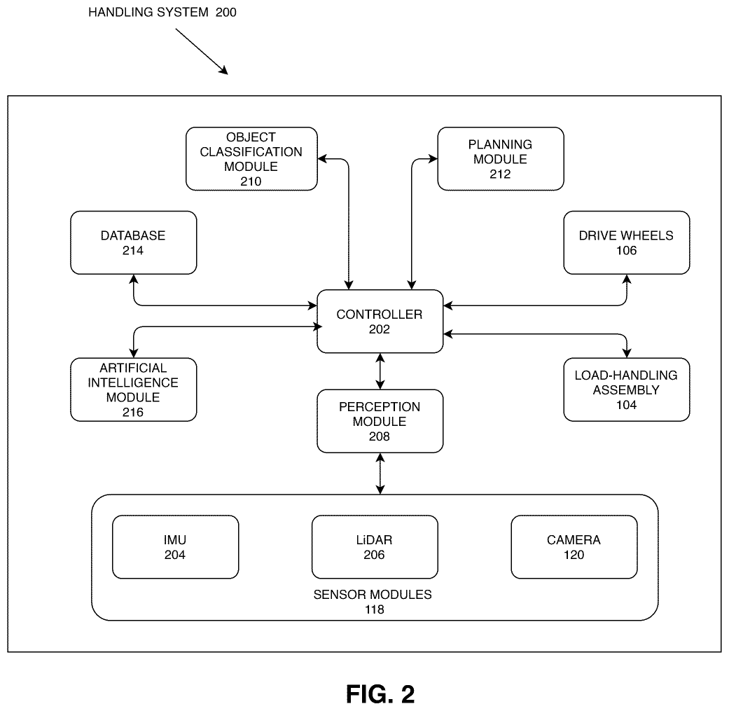

FIG. 2 is a block diagram of a control system for the autonomous forklift 100, according to an embodiment of the present invention. In an embodiment, the control system 200 includes a controller 202 that is communicatively coupled to the sensor modules 118, a perception module 208, an object classification module 210, a planning module 212, the load-handling assembly 104, and the drive wheels 106 via a network. The network may be any type of network suitable to allow interaction between the components of control system 200, such as a CAN bus on-board the autonomous forklift 100. In another embodiment, the network may be a wired network, a wireless network, a mesh network, or any combination thereof.

In an embodiment, the controller 202 consists of computing hardware, such as a processor, and software which is executed by the processor. In an exemplary embodiment the controller 202 is located on-board the autonomous forklift 100. In another embodiment, the controller 202 can include a server coupled to the network. In another embodiment, the controller 202 is cloud-based, and located on remote server, such as on a server provided by Google® Cloud Platform or the like. In yet another embodiment, the controller 202 can be distributed across multiple servers.

In an embodiment, the controller 202 receives input, such as data, from the sensor modules 118, the perception module 208, the object classification module 210, the planning module 212, the database 214, and the artificial intelligence module 216, and provides output, such as commands to the load-handling assembly 104 and the drive wheels 106.

In an embodiment, the sensor modules 118 can include a plurality of sensors including, at least, an IMU 204, a LiDAR system 206, and/or at least one camera 207. In an embodiment, the sensor modules 118 provide a 360 degree field of view around the autonomous forklift 100.

In an embodiment, the IMU 204 combines a plurality of sensors (e.g., accelerometer, gyroscope, magnetometer, pressure sensor . . . ) to provide data regarding the orientation, acceleration, and angular velocity of the autonomous forklift 100. More specifically, an accelerometer of the IMU 204 may measure linear acceleration to determine changes in velocity and direction. Further, a gyroscope of the IMU 204 may measure rotational movements and the magnetometer detects the Earth's magnetic field and to determine orientation information as well as the angle of tilt of the autonomous forklift 100.

In an embodiment, the IMU 204 can be communicatively coupled to the drive wheels 106 and/or the load-handling assembly 104 and can receive signals therefrom. The IMU 204 can collect, for example, information related to speed, velocity, orientation, angular rates, direction, gravitational forces, wheel rotation, and the like, of the drive wheels 106.

Furthermore, the IMU 204 can collect, for example, information related to the weight or load carried, lateral and vertical adjustments of each fork, tilt of the forks 114, and the like.

In an embodiment, the camera 207 may be a line scan or area scan camera, a CCD camera, a CMOS camera, or any other suitable camera used in robotics. The camera 207 may capture images in monochrome or in color. Physically, multiple cameras 120 are respectively located on opposing side at the front of the autonomous forklift 100 adjacent the side-shifter assembly 122 in order to capture the position of the forks 114, as well as the surrounding environment that faces the forward movement direction of the autonomous forklift 110. Additionally, there may be one or more additional cameras disposed on the autonomous forklift 100, such as a camera array and/or multiple cameras located at various other locations on the autonomous forklift 100, such as to provide a 360 degree field of view around the autonomous forklift 100. In an embodiment, the camera 207 captures image data and video data.

The use of the IMU 204, the LiDAR system 206, and the camera 207 in the sensor modules 118 is exemplary, and are not intended to be a limiting. The sensor modules 118 can include various other sensing or detecting devices as described herein.

In an embodiment, the sensor modules 118 can contain additional sensors and/or detectors, such as, for example ultrasonic sensors which can be used to specifically target regions or locations in the operating environment that are likely to contain low clearances or overhanging obstacles.

In an embodiment, additional sensor modules can further be mounted on the forks 114.

In an embodiment, the perception module 208 receives data from the sensor modules 118 collected as the autonomous forklift 100 traverses an environment. The sensor data can include, for example, a collection of low and high resolution video frames and/or images, including but not limited to one or more (e.g., monocular or stereo) color or grayscale light intensity images, 3D depth images, and derived images such as 2D or 3D traversability maps, or sets of features recognized within the data.

The perception module 208 performs object recognition on the sensor data, and determines if overhead obstacles are present in the sensor data. The perception module 208 further determines the height of any overhead obstacles, as well as the shape and angle of the surface traversed by the autonomous forklift 100. For example, if the autonomous forklift 100 is performing a trailer loading or unloading operation, the perception module 208 determines the height of the trailer door, as well as the shape and angle of the dock leveler, so that a maximum clearance height can be computed by the controller 202.

The maximum clearance height is utilized by the controller 202 to command the drive wheels 106 as well as the load-handling assembly 104. For instance, a steeply inclined dock leveler requires a different tilt angle for the forks 114 in order for the autonomous forklift 100 to safely load and extract pallets to and from a trailer.

In an embodiment, the object classification module 210 determines a classification of the obstacle, such as, for example, as being non-deformable or deformable. Examples of non-deformable obstacles can include, but are not limited to, trailer doors, ceilings, in-trailer refrigeration units, air ducts, sprinkler system components, fans, light fixtures, and the like. Example of deformable obstacles can include, but are not limited to, weather guards installed around the periphery of trailer doors, plastic sheeting, curtains, vinyl strips, and the like.

In an embodiment, the planning module 212 generates a plan for commanding the autonomous forklift 100 based on the type of overhead obstacle determined by the object classification module 210. As described with more detail herein, the planning module 212 determines actions such as commanding the drive wheels 106 to proceed travelling through a deformable overhead obstacle, or commanding the drive wheels 106 to stop so that the autonomous forklift 100 does not collide with a non-deformable overhead obstacle. In addition, the planning module 212 determines if the vertical tilt angle and/or vertical height of the forks 114 needs to be adjusted based on the angle and/or levelness of the surface that the autonomous forklift 100 is traversing.

In an embodiment, the database 214 is configured to store various data, receive queries from the controller 202, and return data to the controller 202 in response to the queries. The database 106 can store data collected by the sensor modules 118, data processed by the perception module 208, data collected from the drive wheels 106, data collected from the load-handling assembly 104, classifications determined by the object classification module 210, and/or relevant information generated by the planning module 212.

For example, the database 214 can store data collected by the sensors module 116 related to motion, navigation, speed, and trajectory of the autonomous forklift, as well as overhead obstacles, and motion maneuvers undertaken in the presence of deformable and non-deformable overhead obstacles.

In an embodiment, the data in the database 214 is stored with an identifier related to at least one of a carried pallet, the autonomous forklift, a loading location, a placement location, an overhead obstacle, and/or any combination thereof. In addition, the data in the database 214 can be stored with timestamps.

This data may be stored locally within a database on the autonomous forklift, and can be transmitted to the controller 202, which can process the data, and further transmit data from the sensor modules 118, object classification module 210, planning module 212, and other sensors on the autonomous forklift 100, to the database 214 for storage and subsequent retrieval.

In another embodiment, all or portion of the data can be stored remotely on a remote database which is accessible by the controller 202.

In an embodiment, the artificial intelligence module 216 is communicatively coupled to the controller 202 and/or the database 214. The artificial intelligence module 216 can analyze data collected over time by the sensor modules 118, the load-handling assembly 104 and/or the drive wheels 106. This analysis by the artificial intelligence module 216 allows the controller 202 to process the future data more efficiently, quickly generate commands, and improve the efficiency and accuracy of the control system 200.

For example, the artificial intelligence module 216 can analyze historical overhead obstacle detections to suggest a motion plan for a current operation where the autonomous forklift 100 is traveling in the vicinity of the previously detected overhead obstacle.

In an embodiment, the functions of the perception module 208, the object classification module 210, the planning module 212, and the artificial intelligence module 216 can be performed by the controller 202 (i.e., the controller 202 can include the modules 208, 210, 212, and/or 216 within its hardware and/or software components).

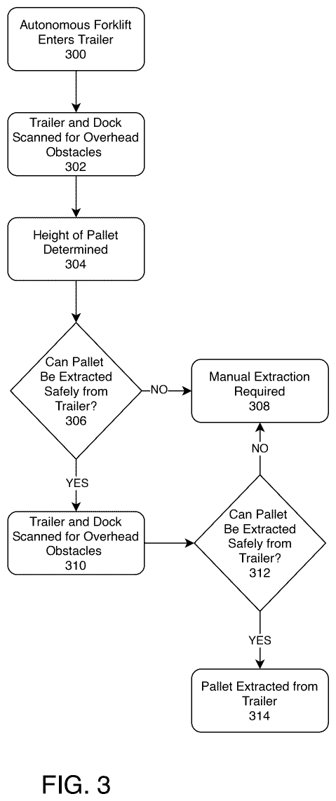

FIG. 3 is a flowchart illustrating the steps of operation of the control system during a trailer unloading operation, according to an embodiment of the present invention. At step 300, the autonomous forklift 100 approaches a loading dock door where a trailer is parked. Many loading dock doors have a dock leveler to compensate for a height difference that may exist between the loading dock floor and an adjacent trailer bed. A typical dock leveler includes a deck that is hinged along its back edge at or near the elevation of the loading dock floor so that the deck can pivotally adjust the height of its front edge to an elevation that generally matches the height of the rear edge of the trailer bed to provide a ramp for material handling equipment, such as the autonomous forklift 100.

At step 302, the sensor modules 118 scan the trailer door and dock door, as well as the loading dock floor which may include a dock leveler. The perception module 208 determines a height of any overhead obstacles, such as a trailer door and/or dock door from the sensor data, and further determines a height of the loading dock floor which can include unevenness, an angle, or a slope. The perception module 208 further determines a maximum clearance height based on the overhead and floor heights calculated from the sensor data.

In addition, the object classification module 210 determines if the overhead obstacle is deformable or non-deformable. The object classification module 210 can leverage the artificial intelligence module 216 which provides machine learning-based object recognition and/or deep learning-based object recognition to determine if the overhead obstacle is deformable or non-deformable.

In the case of deep learning, the artificial intelligence module 216 can utilize a model trained over time (either a pre-trained model or a model trained from scratch) with sensor data which has categorized various deformable objects and non-deformable objects.

In the case of machine learning, the object classification module 210 performs feature extraction on the sensor data, which is provided to a machine learning model of the artificial intelligence module 216 which can separate the extracted features into distinct categories, and then use this information when analyzing and classifying new objects as deformable or non-deformable.

At step 304, the sensor modules 118 scan a pallet and its respective load or cargo (collectively, the “pallet”) that is to be picked by the autonomous forklift 100. The perception module 208 analyzes the sensor data to determine a height and/or shape of the pallet. In some instances, the pallet may not form a perfect cube dimensionally, such that the top of the load may be taller in some portions than in others, instead of having a uniform height across the entire top surface of the load. In these situations, the perception module 208 determines the height of the tallest point of the load.

In an embodiment, the sensor modules 118 scan the pallet prior to the autonomous forklift 100 picking or carrying the pallet on its forks 114, such as when standard pallets having dimensions of approximately 48″×40″ are being handled.

In another embodiment, the sensor modules 118 scan the pallet after it is picked or carried by the forks 114, such as when short or half-sized pallets are being handled.

At step 306, the controller 202 compares the height of the pallet with the maximum clearance height and determines if the pallet can be extracted safely from the trailer without colliding with the overhead obstacle (i.e., if the overhead obstacle is non-deformable), or without tipping over when making contact with the overhead obstacle (i.e., if the overhead obstacle is deformable).

In an embodiment, the controller 202 subtracts the height of the pallet from the maximum clearance height, and if the resulting value is a positive (i.e., the pallet height is smaller than the maximum clearance height), the pallet can be extracted safely from the trailer. If the resulting value is negative (i.e., the pallet height is greater than the maximum clearance height), the pallet is too tall and cannot be extracted safely from the trailer if the overhead obstacle is classified as non-deformable.

In an embodiment, a padding amount is added to the height of the pallet to account for variances (i.e., the tallest point of the load not accurately detected, unevenness of the trailer bed, unevenness of the trailer ceiling, and the like). In an embodiment, the padding amount is a percentage of the height of pallet, such as, for example 2% to 5%. Alternatively, the padding amount is a fixed value, such as 1 inch to 6 inches.

In this embodiment, the controller 202 adds the padding amount to the height of the pallet to obtain a padded height, and the controller subtracts the padded height from the maximum clearance height. If the resulting value is positive, the pallet can be extracted safely from the trailer. If the resulting value is negative, the pallet is too tall and cannot be extracted safely from the trailer if the overhead obstacle is classified as non-deformable.

If the controller 202 determines that the pallet cannot be extracted from the trailer safely (i.e., the height of the pallet, or the padded height, is greater than maximum clearance height, and the overhead obstacle is classified as non-deformable) then the process continues to step 308, where the controller 202 notifies personnel that a manual extraction of the pallet is required.

In an embodiment, at step 308, the controller 202 notifies personnel via a loudspeaker, a visual indicator, and/or an electronic notification transmitted to a computing device operated by personnel, such as a text message, push notification, e-mail, and the like. In an embodiment, the loudspeaker and/or visual indicator can be mounted on the autonomous forklift 100 or located at a location remote from the autonomous forklift 100.

In yet another embodiment, if at step 308 the controller 200 determines that the pallet cannot be extracted from the trailer safely, then the controller 200 commands the autonomous forklift 100 to exit the trailer so that personnel can safely enter and maneuver the pallet within the trailer.

If the controller 202 determines that the height of the pallet, or the padded height, is larger than maximum clearance height, but the overhead obstacle is classified as deformable, then the process continues to step 310 as described in more detail herein.

If, however, the controller 202 determines that the height of the pallet is smaller than the maximum clearance height, then the process continues to step 310 where the height of the overhead obstacle is re-verified to confirm that the maximum clearance height has not changed. The sensor modules 118 scan the interior of the trailer, the trailer bed, the trailer door, and the dock door. The perception module 208 determines if any overhead obstacles exist within the trailer, such as, for example, door components, ceilings, in-trailer refrigeration units, air ducts, sprinkler system components, fans, light fixtures, and the like. If so, the perception module 208 determines the height of the overhead obstacles. In addition, the perception module 208 determines a height of the trailer bed, which in some cases can be uneven, or have sloped or angled portions.

At step 312, the controller 202 determines if the pallet can be safely extracted from the trailer in light of the height of the detected overhead obstacle, as well as the height of the trailer bed. If the pallet height is greater than the height of overhead obstacle, and the overhead obstacle is classified as non-deformable, then the process continues to step 308 where the controller 202 notifies personnel that a manual extraction of the pallet is required, as described herein.

If, however, the controller 202 determined that the pallet height is greater than the height of the overhead obstacle, and the overhead obstacle is classified as deformable, then the process continues to step 314 where the controller 202 commands the autonomous forklift 100 to exit the trailer with the pallet.

Furthermore, if the controller 202 determines that the pallet height is smaller than the height of the overhead obstacle, then the process continues to step 314 where the controller 202 commands the autonomous forklift 100 to exit the trailer with the pallet.

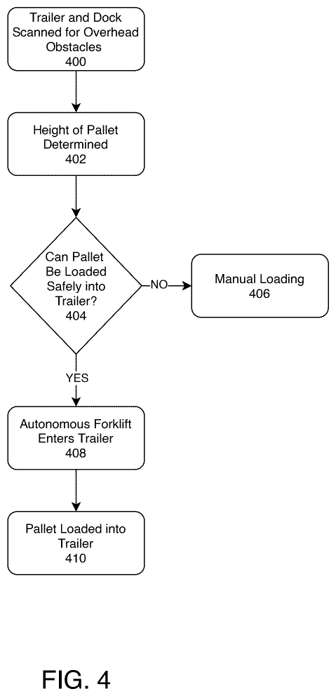

FIG. 4 is a flowchart illustrating the steps of operation of the control system during a trailer loading operation, according to an embodiment of the present invention. At step 400, the sensor modules 118 scan the trailer door and dock door, as well as the loading dock floor which may include a dock leveler. The perception module 208 determines a height of the trailer door and/or dock door from the scanned sensor data, and further determines a height of the loading dock floor which can include a levelness, angle, or slope. The perception module 208 further determines a maximum clearance height based on the overhead and floor heights calculated from the sensor data.

At step 402, the sensor modules 118 scan the pallet intended for loading by the autonomous forklift 100. The perception module 208 analyzes the sensor data to determine a height and/or shape of the pallet. In some instances, the pallet may not form a perfect cube dimensionally, such that the top of the load may be taller in some portions than in others, instead of having a uniform height across the entire top surface of the load. In these situations, the perception module 208 determines the height of the tallest point of the load.

At step 404, the controller 202 compares the height of the pallet with the maximum clearance height, and determines if the pallet can be safely loaded into the trailer without colliding with the overhead obstacle (i.e., if the overhead obstacle is non-deformable), or without tipping over when coming into contact with the overhead obstacle (i.e., if the overhead obstacle is deformable).

In an embodiment, the controller 202 subtracts the height of the pallet from the maximum clearance height, and if the resulting value is a positive (i.e., the pallet height is smaller than the maximum clearance height), the pallet can be safely placed into the trailer. If the resulting value is negative (i.e., the pallet height is greater than the maximum clearance height), the pallet is too tall and cannot be safely placed into the trailer if the overhead obstacle is classified as deformable.

In an embodiment, a padding amount is added to the height of the pallet to account for variances (i.e., the tallest point of the load not accurately detected, unevenness of the dock leveler, and the like). In an embodiment, the padding amount is a percentage of the height of pallet, such as 2% to 5%. Alternatively, the padding amount is a fixed value, such as 1 inch to 6 inches.

In this embodiment, the controller 202 adds the padding amount to the height of the pallet to obtain a padded height, and the controller subtracts the padded height from the maximum clearance height. If the resulting value is positive, the pallet can be placed safely into the trailer. If the resulting value is negative, the pallet is too tall and cannot be placed safely into the trailer.

If the controller 202 determines that the pallet cannot be placed into the trailer safely (i.e., the height of the pallet, or the padded height, is larger than maximum clearance height, and the overhead obstacle is classified as non-deformable) then the process continues to step 406 where the controller 202 notifies personnel that a manual placing of the pallet into the trailer is required.

If the controller 202 determines that the height of the pallet, or the padded height, is larger than maximum clearance height, but the overhead obstacle is classified as deformable, then the process continues to step 408 as described in more detail herein.

If, however, the controller 202 determines that the height of the pallet is smaller than the maximum clearance height, then the process continues to step 408 where the controller 202 commands the autonomous forklift 100 to enter the trailer, and subsequently place the pallet within the trailer at step 410.

FIG. 5 is a side-view diagram of an autonomous forklift depicting fields of view of the sensor modules, according to an embodiment of the present invention. The autonomous forklift includes a first sensor module 118a facing in the direction of the forks 114, and a second sensor module 118 facing in an opposite direction away from the forks 114. Each sensor module 118a, 118b has a respective field of view 500, 502 that allows data to be captured in a forward and reverse direction of travel of the autonomous forklift 100.

In another embodiment, an additional sensor module (not shown in FIG. 5) is mounted on a mounting backplate of the forks 114, and the additional sensor module is raised via adjustment of the mounting backplate prior to picking a pallet 504 in order to achieve a desired field of view and/or detection height.

As shown in FIG. 5, the first sensor module 118a has a field of view 500 that can detect the height of a pallet 504. The second sensor module 118b has a field of view 502 that can detect the height of any overhead objects that may be encountered as the autonomous forklift 100 travels toward the exit of the trailer.

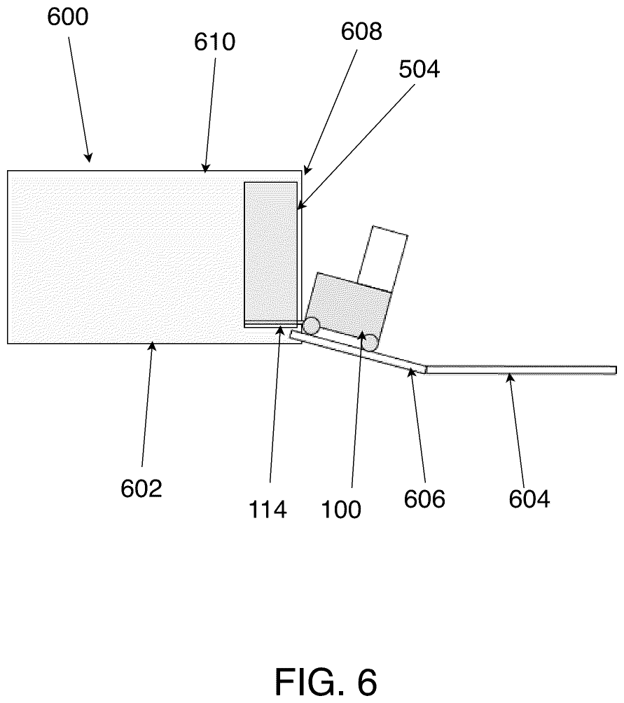

FIG. 6 is a side-view diagram of an autonomous forklift maneuvering on a dock leveler, according to an embodiment of the present invention. As shown in FIG. 6, the height of the trailer bed 602 is higher than the height of the loading dock floor 604. To compensate for this height difference, a dock leveler 606 is utilized so that the autonomous forklift 100 can travel into the trailer 600 from the loading dock floor 604, and also onto the loading dock floor 604 from within the trailer 600.

In an embodiment, the sensor modules 118 actively detect the height of overhead obstacles, such as the trailer door 608 and the trailer ceiling 610. The controller 202 can dynamically adjust the height and/or vertical tilt of the forks 114 as the autonomous forklift 100 moves into and out of the trailer 600 based on the detected heights of the overhead obstacles. For example, during transit between the trailer bed 602 and the dock leveler 606, the vertical height of the forks 114 may need to be adjusted so that the pallet 504 does not collide with the dock door 608 or the trailer ceiling 610.

FIG. 7 is a side-view diagram of an autonomous forklift maneuvering within a trailer, according to an embodiment of the present invention. The controller 202 can dynamically adjust the height of the forks 114 in order to maximize the field of view, visibility, and/or line of sight of a low-level sensor module 700. In an embodiment, the low-level sensor module 118c is located at a lower portion of the autonomous forklift 100, the forks 114 are raised so that the field of view 700 of the sensor module 118 is not obstructed by the forks 114 and/or the pallet 504.

In addition to adjusting the height of the forks 114 to prevent collisions with overhead obstacles, the forks 114 are raised to a sufficient height to allow for the low-level sensor module 118c to see beneath the forks 114 (and inherently under the pallet 504). This sufficient height can range from 3 inches to 10 inches, and in a preferred embodiment, ranges from 6 inches to 8 inches.

In an embodiment, obstruction of the field of view 700 of the low-level sensor module 118c may occur when there is insufficient overhead clearance to carry the pallet high enough to clear the field of view 700. Due to this limited field of view, when the field of view 700 is obstructed, the autonomous forklift 100 may be unable to detect and avoid collisions with certain obstacles in its path and may need to operate at a reduced speed. In some circumstances, the field of view 700 may only need to be obstructed momentarily, for example during trailer entry, and can be cleared while inside the trailer once the pallet is raised by the fork assembly.

In an embodiment, the controller 202 can adjust of the height of the forks 114 after determining the height of any overhead obstacles, as described herein with respect to FIG. 2 and FIG. 3.

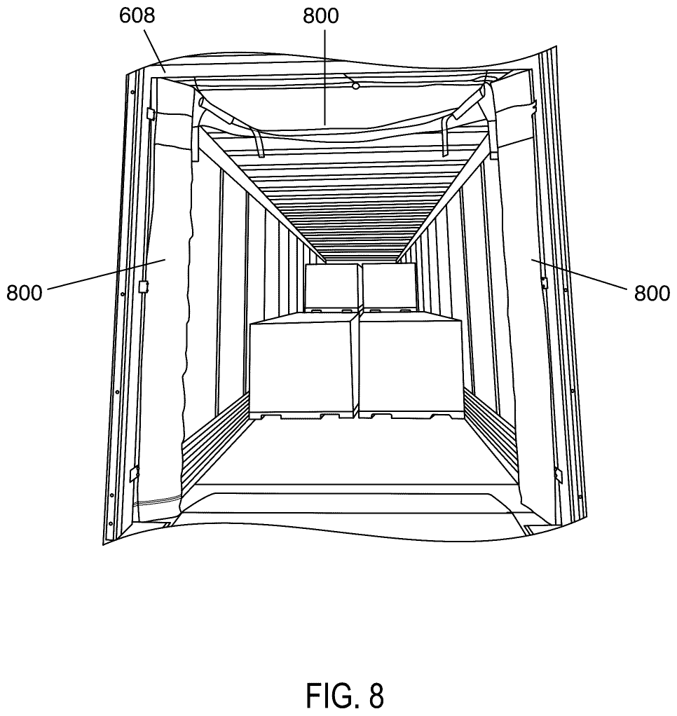

FIG. 8 is a view illustrating a dock door with a deformable weather guard. The dock door 608 includes a deformable weather guard 800 which permits a pallet having a height greater than the height of the weather guard 800 to traverse through the dock door 608. As the weather guard 800 is deformable, the pallet will not be susceptible to falling, tipping, or otherwise being damaged by the weather guard 800.

The weather guard 800 depicted in FIG. 8 is only an example of a deformable obstacle, and other deformable obstacles as described herein may be utilized at the inner periphery of the dock door 608.

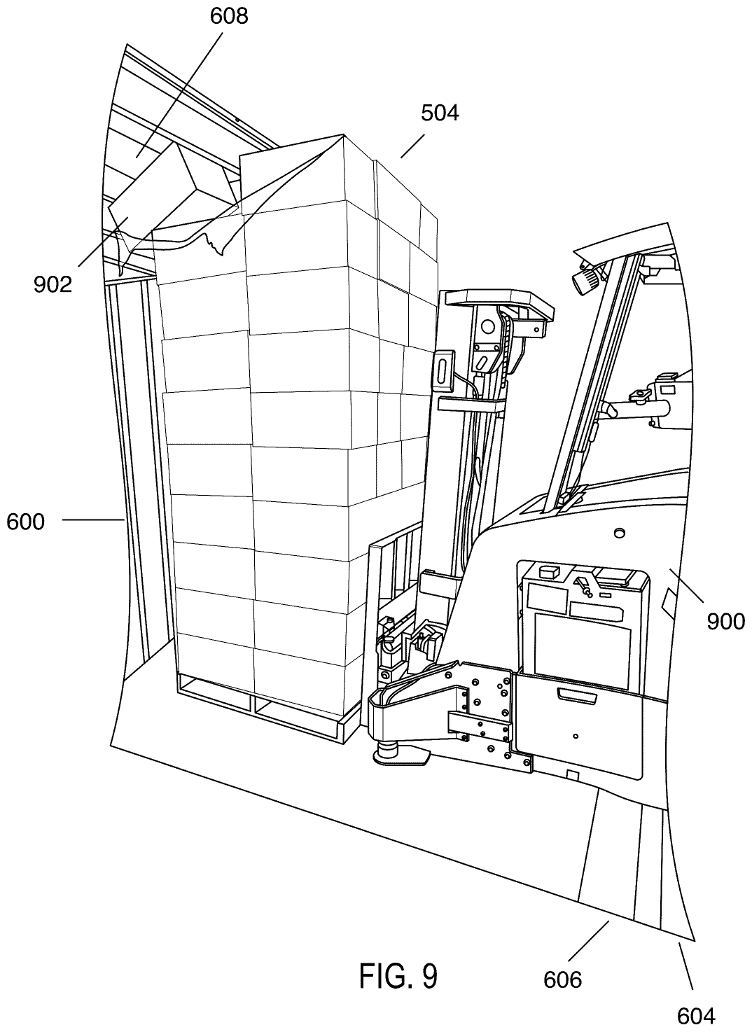

FIG. 9 is a diagram illustrating a prior art autonomous forklift system that does not incorporate height estimation. The prior art autonomous forklift 900 is not capable of intelligently maneuvering in the presence of overhead obstacles which may collide with a pallet 504. As shown in FIG. 9, the pallet 504 has a height greater than the height of the dock door 608. As the autonomous forklift 900 traverses out of the trailer 600, a portion of the load 902 on the pallet 504 collides with the dock door 608. Such collisions risk damage to the load 902, the dock door 908, and/or the surrounding environment where there may be other cargo, equipment, and personnel.

The present invention, as described herein, provides systems and methods to prevent the collision depicted in FIG. 9.

While the principles of the disclosure have been illustrated in relation to the exemplary embodiments shown herein, the principles of the disclosure are not limited thereto and include any modification, variation, or permutation thereof.

What is claimed is:

1. An autonomous forklift, comprising:
a controller;
a fork assembly having an actuator coupled to the controller, the actuator configured to adjust the fork assembly; and
a sensor coupled to the controller, the sensor positioned to capture (i) a view above a path of the autonomous forklift, and (ii) a view of a load,
wherein the controller is configured to:
(1) receive data from the sensor,
(2) analyze the data to detect an obstacle above the path of the autonomous forklift,
(3) analyze the data to determine a height of the obstacle,
(4) analyze the data to determine if the obstacle is deformable or non-deformable,
(5) analyze the data to determine a height of the load,
(6) if the height of the load is greater than the height of the obstacle, then
(i) command the autonomous vehicle to travel through the obstacle if the obstacle is deformable, or
(ii) command the autonomous vehicle to avoid travel through the obstacle if the obstacle is non-deformable, and
(7) if the height of the load is smaller than the height of the obstacle, command the autonomous vehicle to travel through the obstacle.

2. The system of claim 1, wherein the sensor includes at least two sensing devices, each sensing device selected from a group consisting of a Light Detection and Ranging (“LiDAR”) system and a camera.

3. The system of claim 1, wherein the controller is further configured to notify personnel if (i) the height of the load is greater than the height of the obstacle and (ii) the obstacle is non-deformable.

4. The system of claim 1, wherein the controller is further configured to analyze the data to detect a height of a surface traversed by the autonomous forklift.

5. The system of claim 4, wherein the controller is further configured to determine the height of the obstacle relative to the height of the surface traversed by the autonomous forklift.

6. The system of claim 1, wherein the controller is further configured to command the actuator to adjust a height or tilt of the fork assembly based on the height of the obstacle or based on the height of the load.

7. The system of claim 1, wherein the controller is further configured to command the actuator to adjust a height or tilt of the fork assembly based on a difference between the height of the obstacle and the height of the load.

8. An autonomous forklift, comprising:
a controller;
a fork assembly mounted on a fork side of the autonomous forklift, the fork assembly having an actuator coupled to the controller, the actuator configured to adjust the fork assembly;
a first sensor coupled to the controller and mounted on the fork side, the first sensor positioned to capture (i) a view above a path in a direction of the fork side and (ii) a view of a load; and
a second sensor coupled to the controller and mounted on a counterweight side of the autonomous forklift, the second sensor positioned to capture a view above a path in a direction of the counterweight side,
wherein the controller is configured to:
(1) receive first data from the first sensor,
(2) analyze the first data to detect an obstacle above the path in the direction of the fork side,
(3) analyze the first data to determine a height of the obstacle,
(4) analyze the first data to determine if the obstacle is deformable or non-deformable,
(5) analyze the first data to determine a height of the load,
(6) receive second data from the second sensor, and
(7) analyze the second data to detect an obstacle above the path in the direction of the counterweight side.

9. The system of claim 8, wherein each of the first sensor and second sensor are selected from a group consisting of a Light Detection and Ranging (“LiDAR”) system and a camera.

10. The system of claim 8, wherein the controller is further configured to notify personnel if (i) the height of the load is greater than the height of the obstacle and (ii) the obstacle is non-deformable.

11. The system of claim 8, wherein the controller is further configured to analyze the first data or the second data to detect a height of a surface traversed by the autonomous forklift.

12. The system of claim 11, wherein the controller is further configured to determine the height of the obstacle relative to the height of the surface traversed by the autonomous forklift.

13. The system of claim 8, wherein the controller is further configured to command the actuator to adjust a height or tilt of the fork based on the height of the obstacle or based on the height of the load.

14. The system of claim 8, wherein the controller is further configured to command the actuator to adjust a height or tilt of the fork based on a difference between the height of the obstacle and the height of the load.

15. An autonomous forklift, comprising:
a controller;
a fork assembly having an actuator coupled to the controller, the actuator configured to adjust the fork assembly; and
a sensor coupled to the controller, the sensor positioned to capture (i) a view above a path of the autonomous forklift, (ii) a view of a surface traversed by the autonomous forklift, and (iii) a view of a load,
wherein the controller is configured to:
(1) receive data from the sensor,
(2) analyze the data to detect an obstacle above the path of the autonomous forklift,
(3) analyze the data to determine a height of the obstacle,
(4) analyze the data to detect a height of a surface traversed by the autonomous forklift,
(5) determine a clearance height based on a difference between the height of the obstacle and the height of the surface;
(6) analyze the data to determine if the obstacle is deformable or non-deformable,
(7) analyze the data to determine a height of the load,
(8) if the height of the load is greater than the clearance height, then
(i) command the autonomous vehicle to travel through the obstacle if the obstacle is deformable, or
(ii) command the autonomous vehicle to avoid travel through the obstacle if the obstacle is non-deformable, and
(9) if the height of the load is smaller than the clearance height, command the autonomous vehicle to travel through the obstacle.

16. The system of claim 15, wherein the sensor includes at least two sensing devices, each sensing device selected from a group consisting of a Light Detection and Ranging (“LiDAR”) system and a camera.

17. The system of claim 15, wherein the controller is further configured to command the actuator to adjust a height or tilt of the fork assembly based on the height of the obstacle or based on the height of the load.

18. The system of claim 15, wherein the controller is further configured to command the actuator to adjust a height or tilt of the fork assembly based on a difference between the height of the obstacle and the height of the load.

19. The system of claim 15, wherein the surface is a dock leveler.

20. The system of claim 15, wherein the controller is further configured to analyze the data to detect an angle of the surface traversed by the autonomous forklift.
